(19) United States
(12) Patent Application Publication
(10) Pub. No.: US 2025/0378079 A1
(43) Pub. Date: Dec. 11, 2025

(54) DATA ANALYSIS DEVICE, DATA ANALYSIS METHOD, AND STORAGE MEDIUM

(71) Applicant: NEC CORPORATION, Tokyo (JP)

(72) Inventors: Takuma NOZAWA, Tokyo (JP); Ryoichi KINOSHITA, Tokyo (JP); Hidekazu YUGE, Tokyo (JP)

(73) Assignee: NEC Corporation, Tokyo (JP)

(21) Appl. No.: 19/228,945

(22) Filed: Jun. 5, 2025

(30) Foreign Application Priority Data
Jun. 10, 2024 (JP) 2024-093644

(51) Int. Cl. G06F 16/2457; G06F 16/3329

(52) U.S. Cl. CPC G06F 16/24573; G06F 16/24578; G06F 16/3329

(57) ABSTRACT

The data analysis device 1X mainly includes an analytic query generation means 52X, an insight generation means 53X, and a metadata generation means 54X. The analytic query generation means 52X is configured to generate, from data, an analytic query for analyzing the data. The insight generation means 53X is configured to generate an insight of the data based on the data and the analytic query. The metadata generation means 54X is configured to generate metadata of the data based on the insight to support decision making.

### INCORPORATION BY REFERENCE

This application is based upon and claims the benefit of priority from Japanese Patent Application No. 2024-093644, filed on Jun. 10, 2024, the disclosure of which is incorporated herein in its entirety by reference.

### TECHNICAL FIELD

The present disclosure relates to a technical field of a data analysis deice, a data analysis method and a storage medium for performing processing related to data analysis.

### BACKGROUND

There are systems which use metadata. For example, Patent Literature 1 discloses a technique for making a natural language analysis model using metadata given by the user.

### CITATION LIST

### Patent Literature

Patent Literature 1: JP 2023-051423A

### SUMMARY

In manually generating useful metadata for managing data, there is an issue that it takes a huge amount of time. Thus, it is not realistic to manually assign useful metadata.

In view of the above-described issues, one object of the present disclosure is to provide a data analysis device, a data analysis method, and a storage medium capable of automatically generating metadata.

In an example aspect of the present disclosure, there is provided a data analysis device including:
an analysis query generation means configured to generate, from data, an analytic query for analyzing the data;
an insight generation means configured to generate an insight of the data based on the data and the analytic query; and
a metadata generation means configured to generate metadata of the data based on the insight.

In an example aspect of the present disclosure, there is provided a data analysis method executed by a computer, including:
generating, from data, an analytic query for analyzing the data;
generating an insight of the data based on the data and the analytic query; and
generating metadata of the data based on the insight.

In an example aspect of the present disclosure, there is provided a program executed by a computer, the program causing the computer to:
generate, from data, an analytic query for analyzing the data;
generate an insight of the data based on the data and the analytic query; and
generate metadata of the data based on the insight.

An example advantage according to the present disclosure is to automatically generate metadata.

### BRIEF DESCRIPTION OF THE DRAWINGS

FIG. 1 illustrates a configuration of a data analysis system.

FIG. 2 illustrates a hardware configuration of a data analysis device.

FIG. 3 illustrates an outline of a metadata generation process.

FIG. 4 illustrates an example of a functional block of a processor.

FIG. 5 illustrates an example of functional blocks of the data analysis device.

FIG. 6 illustrates an outline of the generation of an analytic query using an LLM.

FIG. 7 illustrates a specific example of generating an analytic query using the LLM.

FIG. 8 illustrates the outline of the generation process of the insight using the chart recommendation model or the question answering model.

FIG. 9 illustrates a specific example of the generation process of the insight using the chart recommendation model and the question answering model.

FIG. 10 illustrates a display example of a data display screen image for the user to confirm data and the metadata of the data.

FIG. 11 illustrates a display example of the data display screen image after the “Add Metadata” button is selected.

FIG. 12 illustrates a display example of the data display screen image after the hyperlink “First Highlight” is selected.

FIG. 13 illustrates an example of a flowchart showing an outline of a process performed by the data analysis device.

FIG. 14 illustrates the configuration of the data analysis system.

FIG. 15 illustrates functional blocks of a data analysis device.

FIG. 16 illustrates an example of a flowchart showing a processing procedure of the data analysis device.

### EXAMPLE EMBODIMENTS

Hereinafter, with reference to the drawings, example embodiments of a data analysis device, a data analysis method and a storage medium will be described. Hereafter, the term “query” refers to an inquiry in natural language (including a question and a hypothetical sentence). The term “answer” refers to a sentence in a natural language, or its text data, output by the system in response to a query. The term “insight” for target data of analysis is information, which indicates some suggestion on the target data, obtained by analyzing the target data of analysis, and examples of the insight include data which is useful information to answer a query regarding the target data of analysis. The term “data catalog” refers to a searchable inventory of data assets in an organization, and includes metadata which is data that describes or summarizes data.

### First Example Embodiment

### (1) System Configuration

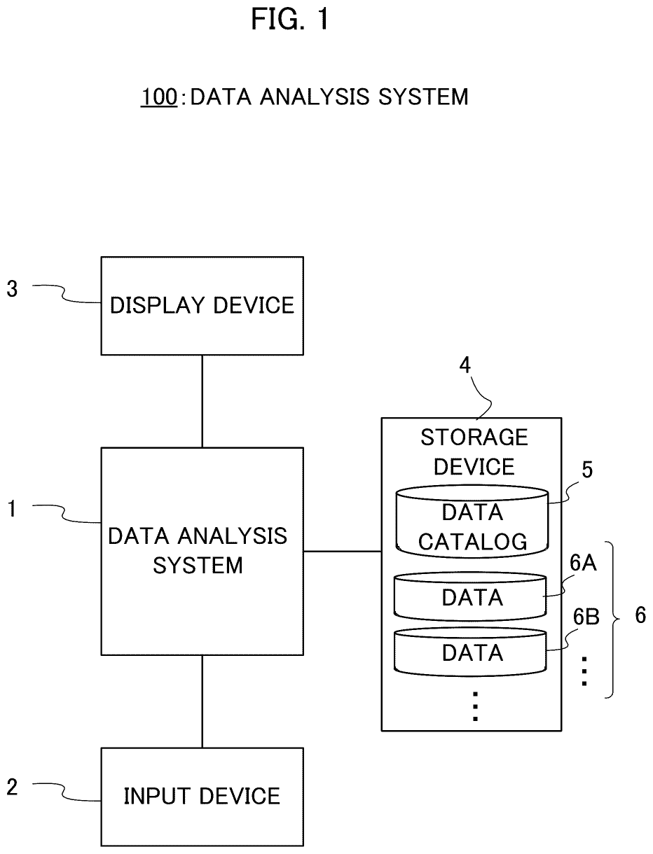

FIG. 1 illustrates the configuration of a data analysis system 100. The data analysis system 100 mainly includes a data analysis device 1, an input device 2, a display device 3, and a storage device 4.

The data analysis device 1 generates metadata of the data registered in the data catalog 5 and outputs the generated metadata. Examples of “outputting metadata” include registering metadata in the data catalog 5 and displaying metadata. Hereafter, the data to be analyzed by the data analysis device 1 for generating metadata is also referred to as “analysis target data”. The analysis target data is a table (database) containing multiple records.

The data analysis device 1 performs data communication with the input device 2, the display device 3, and the storage device 4 respectively through the communication network or through wireless or wired direct communication.

The input device 2 is one or more interfaces for receiving a user input that is an external input, and examples of the input device 2 include a touch panel, a button, a keyboard, and a voice input device. The input device 2 supplies the input information generated based on the user input to the data analysis device 1.

The examples of the display device 3 include a display, and a projector, and the display device 3 performs a predetermined display based on the display information supplied from the data analysis device 1.

The storage device 4 is one or more memories for storing various information necessary for processing performed by the data analysis device 1. The storage device 4 stores a data catalog 5, plural pieces of data 6 registered in the data catalog 5 (6A, 6B, . . . ). The data catalog 5 at least includes metadata associated with each piece of data 6 for making the data 6 searchable. The metadata contained in the data catalog 5 includes not only general default metadata (file name, data source, data format, schema, creation date, and the like) but also metadata generated by the data analysis device 1. Each piece of the data 6 is a database that can be used by an organization (e.g., a company) that manages the data analysis system 100, and the metadata of each piece of the data 6 is registered as target data of search (i.e., searchable data) in the data catalog 5. In FIG. 1, data 6A and data 6B are shown as exemplary data 6.

The storage device 4 may store various information required for processing by the data analysis device 1 in addition to the data catalog 5 and the data 6. The storage device 4 may store, for example, model information (configuration information) for building a large language model (Large Language Model: LLM), model information for building a natural language understanding model used for natural language processing, and the like.

The model information includes various parameters of the learned deep learning model regarding the layer structure, the neuron structure of each layer, the number of filters and filter size in each layer, and the weight for each element of each filter.

A description will be given of the definition of a large language model and a language model. The language model is a machine learning model which is trained to learn the relation among words in sentences and generates a string related to a target string. By using a language model which is trained by use of a variety of contexts and sentences, it is possible to generate a string related to a target string with reasonable description.

For example, a case where a language model is used in answering to a question will be described. The language model takes, as input, the question “What is Japan like?” as the target string. The input question is also referred to as a “prompt”. The language model generates, as the answer to the question, a string “Japan is in an island country in the northern hemisphere . . . ”.

The training method of the language model is not particularly limited, but may be one that is trained to output at least one sentence including an input string, as an example.

Examples of the language model include a GPT (Generative Pre-trained Transformer), which is configured to output a sentence containing the input string by predicting a probable string to follow the input string, and a ChatGPT based on the GPT. Other examples of the language model include T5 (Text-to-Text Transfer Transformer), BERT (Bidirectional Encoder Representations from Transformers), RoBERTa (Robustly optimized BERT approach), and ELECTRA (Efficiently Learning an Encoder that Classifies Token Replacements Accurately).

The storage device 4 may be a storage device such as a hard disk connected or embedded in the data analysis device 1, or may be a storage medium such as a flash memory. The storage device 4 may be a server device that performs data communication with the data analysis device 1. In this case, the storage device 4 may be comprised of a plurality of server devices.

The configuration of the data analysis system 100 shown in FIG. 1 is an example, and various changes may be made to the configuration. For example, the input device 2 and the display device 3 may be configured integrally. In this case, the input device 2 and the display device 3 may be configured as a tablet-type terminal integrated with the data analysis device 1. In some embodiments, the data analysis device 1 may incorporates or is connected to a sound output device such as a speaker for outputting sound to thereby output information by sound. The data analysis device 1 may be configured by a plurality of devices. In this case, the plurality of devices constituting the data analysis device 1 exchange information necessary to execute the processes allocated in advance, among the plurality of devices.

### (2) Hardware Configuration of Data Analysis Device

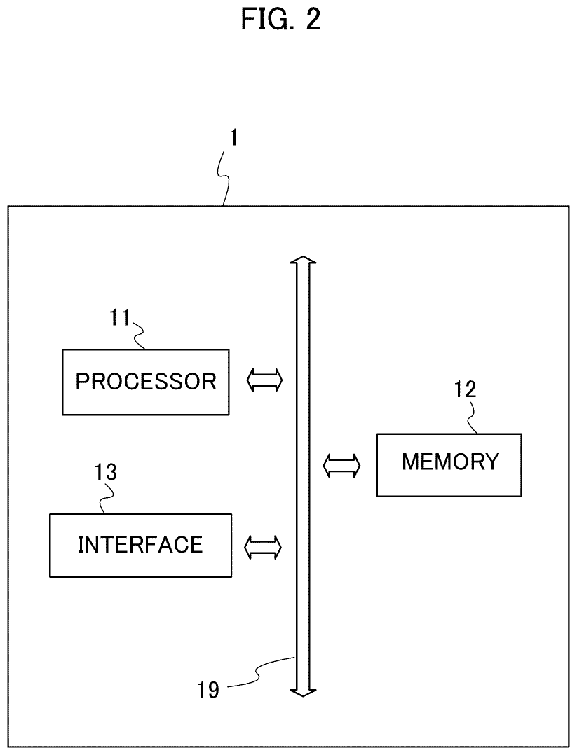

FIG. 2 shows a hardware configuration of the data analysis device 1. The data analysis device 1 includes a processor 11, a memory 12, and an interface 13 as hardware. The processor 11, memory 12 and interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is comprised of various volatile memories and non-volatile memories such as a RAM (Random Access Memory) and a ROM (Read Only Memory). Further, a program for executing various kinds of process by the data analysis device 1 is stored in the memory 12.

The memory 12 is used as a working memory to temporarily store information and the like acquired from the storage device 4. The memory 12 may function as a storage device 4. Similarly, the storage device 4 may function as the memory 12 of the data analysis device 1. The program executed by the data analysis device 1 may be stored in a storage medium other than the memory 12.

The interface 13 is one or more interfaces for electrically connecting the data analysis device 1 to other devices. Examples of the interfaces include a wireless interface, such as a network adapter, for transmitting and receiving data to and from other devices wirelessly, and a hardware interface, such as a cable, for connecting to other devices.

The hardware configuration of the data analysis device 1 is not limited to the configuration shown in FIG. 2. For example, the data analysis device 1 may include at least one of the input device 2 and/or the display device 3. The data analysis device 1 may be connected to or incorporate a sound output device such as a speaker.

### (3) Processing Overview

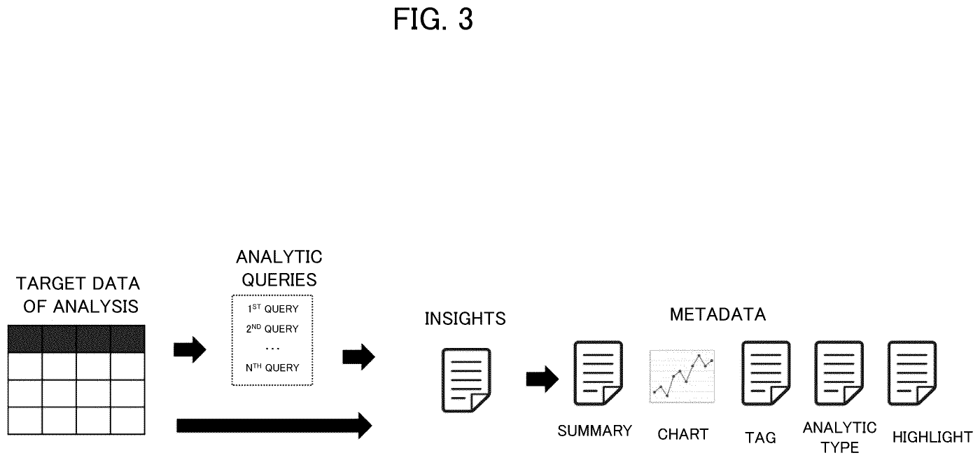

FIG. 3 is a diagram illustrating an overview of a metadata generation process that is performed by the data analysis device 1.

As shown in FIG. 3, upon acquiring the analysis target data, the data analysis device 1 generates an analytic queries for analyzing the analysis target data. Then, the data analysis device 1 generates insights of the analysis target data based on the analytic queries and the analysis target data. Thereafter, the data analysis device 1 generates metadata from the insights. Here, the data analysis device 1 may generate various data as metadata. Examples of the metadata generated by the data analysis device 1 include, as shown in FIG. 3, a summary that is text data obtained by summarizing the analysis target data, a chart which is visualized analysis target data, a tag which represents the analysis target data, an analysis type which is effective for analyzing the analysis target data, and a highlight of the analysis target data. The highlight refers to, for example, a portion (attention part) of the analysis target data which best represents the analysis target data, and may further include supplementary information relating to the portion. A summary is an example of “text data obtained by summarizing data”.

Here, a supplementary explanation will be given of the effect of the automatic generation of metadata by the data analysis device 1.

In general, the viewpoints of “invoking”, “retrieval”, and “understanding” are important for the construction of data catalogs for the promotion of the utilization of data. From the viewpoint of “invoking”, the data catalog is required to be able to invoke what can be found using the data catalog. In addition, from the viewpoint of “retrieval”, the data catalog is required to enable retrieval for easily reaching desired data, and from the viewpoint of “understanding”, it is required to enable smooth grasp of the contents and analysis results of data, respectively. Then, by constructing a data catalog with the conditions of such viewpoints, the user can smoothly discover desired data through the data catalog, so that the analysis on accumulated data and data-driven decision-making are preferably promoted. On the other hand, if the superficial profile of the data is made as the metadata, the data catalog does not sufficiently have the viewpoints of the above-mentioned “invoking”, “retrieval”, and “understanding”. In contrast, manual annotation of useful metadata is enormously expensive and there is a limit. In view of the above, the data analysis device 1 in the present example embodiment automatically generates useful metadata of the analysis target data in consideration of the insights of the analysis target data.

### (3) Functional Blocks

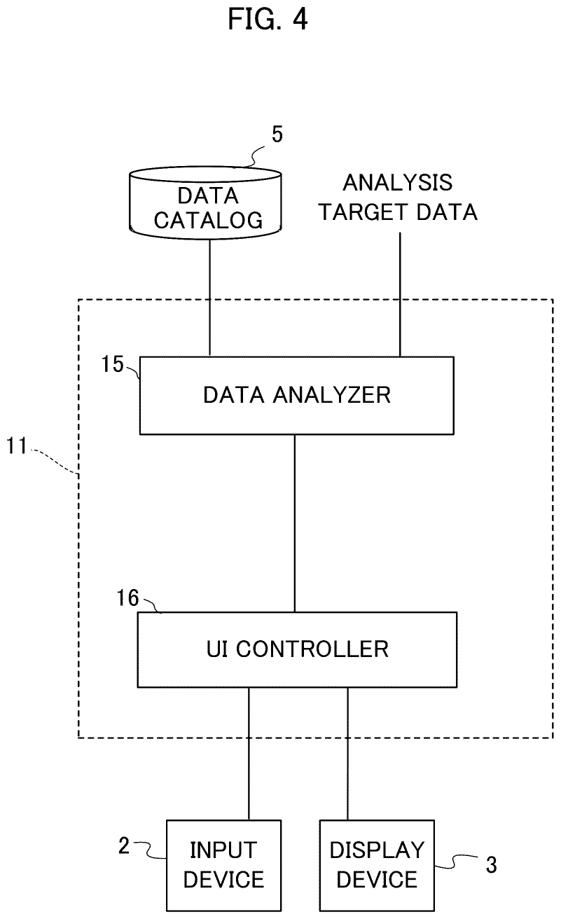

FIG. 4 is an example of functional blocks of the processor 11. The processor 11 functionally includes a data analyzer 15 and a UI (User Interface) controller 16.

The data analyzer 15 refers to information stored in the storage device 4 and the memory 12 to generate metadata of the analysis target data selected from the data 6 registered in the data catalog 5. In this instance, the data analyzer 15 may select the analysis target data based on the user input information supplied from the UI controller 16 or may select the analysis target data from the data 6 registered in the data catalog 5 based on a predetermined rule (including random extraction). Further, the data analyzer 15 may generate metadata of the updated data 6 when the data 6 is updated, and update the metadata associated with the updated data 6 in the data catalog 5 based on the generation result. The data analyzer 15 supplies the generated metadata to the UI controller 16.

The UI controller 16 receives the user input and controls the display of the information to be viewed by the user. For example, the UI controller 16 may supply information specifying the analysis target data to the data analyzer 15 based on input information (i.e., external input) supplied from the input device 2. The UI controller 16 generates the display information based on the metadata generation result generated by the data analyzer 15, and then performs display control of the display device 3 by supplying the generated display information to the display device 3. The specific processes of the UI controller 16 will be described later with reference to the following display examples.

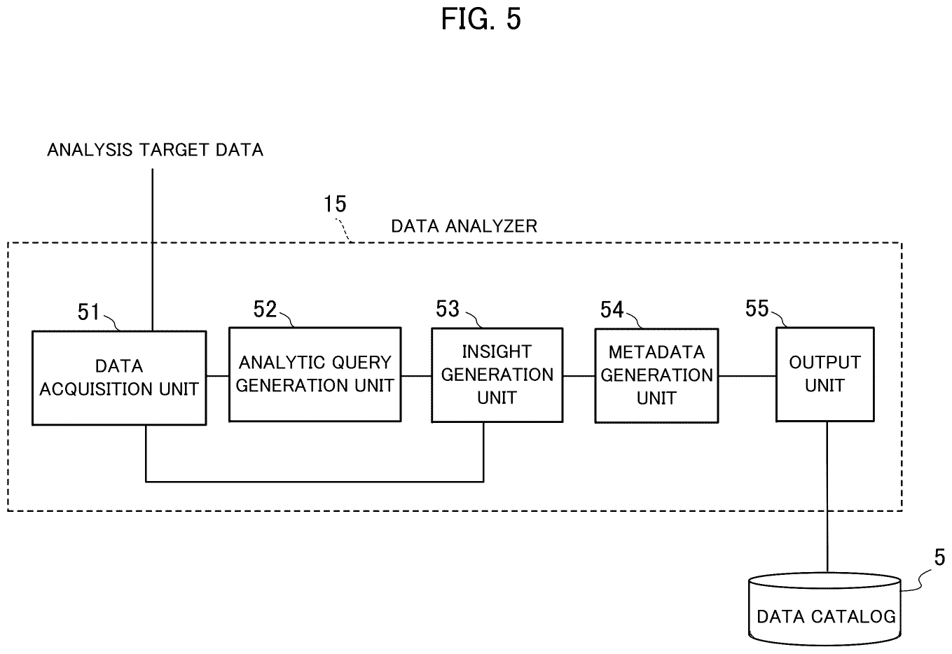

FIG. 5 shows an example of functional blocks of the data analyzer 15. The data analyzer 15 functionally includes a data acquisition unit 51, an analytic query generation unit 52, an insight generation unit 53, a metadata generation unit 54, and an output unit 55. In FIG. 5, blocks to exchange data with each other are connected by a solid line, but the combination of blocks to exchange data with each other is not limited to the combination shown in FIG. 3. The same applies to the drawings of other functional blocks described below.

The data acquisition unit 51 reads out any piece of the data 6 registered in the data catalog 5 from the storage device 4 as the analysis target data. For example, upon receiving the information specifying the analysis target data from the UI controller 16, the data analyzer 15 reads out the specified data 6 as the analysis target data from the storage device 4. In another example, the data analyzer 15 detects a piece of the data 6 in which the metadata is not generated or the metadata needs to be updated, and reads out the detected piece of the data 6 as the analysis target data from the storage device 4. The data analyzer 15 may be sequentially read out from the storage device 4 each of the data 6 registered in the data catalog 5 as the analysis target data. The data acquisition unit 51 supplies the acquired analysis target data to the analytic query generation unit 52 and the insight generation unit 53.

The analytic query generation unit 52 generates analytic queries based on the analysis target data supplied from the data acquisition unit 51. The specific approach to generate analytic queries will be described later. The analytic query generation unit 52 supplies the generated analytic queries to the insight generation unit 53.

The insight generation unit 53 generates insights of the analysis target data based on the analysis target data supplied from the data acquisition unit 51 and the analytic queries supplied from the analytic query generation unit 52. The specific approach to generate the insights will be described later. The insight generation unit 53 supplies the generated insights to the metadata generation unit 54.

The metadata generation unit 54 generates the metadata of the analysis target data based on the insights supplied from the insight generation unit 53. In this case, the metadata generation unit 54 generates metadata including, for example, at least one of a summary, a chart, a tag, an analysis type, and/or a highlight related to the analysis target data. If the insights generated by the insight generation unit 53 is a summary and a chart, the metadata generation unit 54 may include the summary and the chart in the metadata. The metadata generation unit 54 supplies the generated metadata to the output unit 55. The output unit 55 registers the metadata generated by the metadata generation unit 54 in the data catalog 5 in association with the target analysis data.

The data analyzer 15 and the UI controller 16 described in FIG. 4, and the data acquisition unit 51, the analytic query generation unit 52, the insight generation unit 53, the metadata generation unit 54, and the output unit 55 described in FIG. 5 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using a user programmable integrated circuit such as a FPGA (Field-Programmable Gate Array) and a microcontroller. In this case, the integrated circuit may be used to realize a program to function as each of the above components. Further, at least some of the components may be realized by ASSP (Application Specific Standard Produce), ASIC (Application Specific Integrated Circuit), or quantum processor (quantum computer control chip). Thus, each component may be implemented by various hardware. The above is also true for other example embodiments described later. Furthermore, each of these components may be implemented by the cooperation of a plurality of computers, for example, using cloud computing technology.

### (4) Generation of Analytic Query

Next, a process of generating analytic queries executed by the analytic query generation unit 52 will be described. The analytic query generation unit 52 analyzes the analysis target data and generates the analytic queries. In this case, the analytic query generation unit 52 may generate analytic queries by any method. For example, the analytic query generation unit 52 may generate analytic queries using an LLM. Hereafter, as a typical example, generation of analytic queries using an LLM will be described.

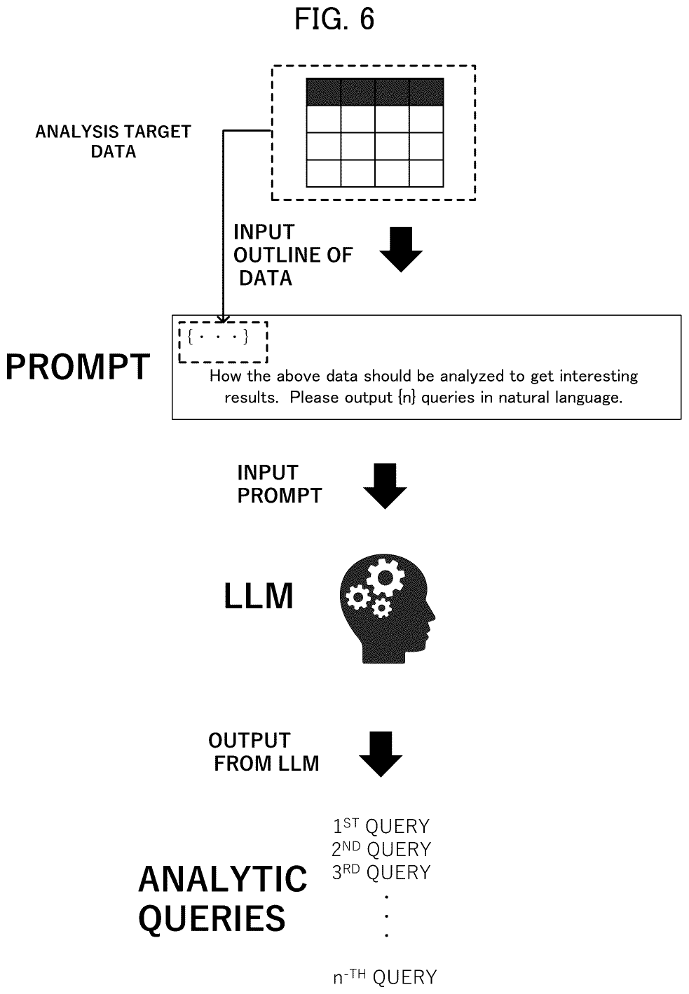

FIG. 6 shows an outline of the generation of an analytic query using an LLM.

The analytic query generation unit 52 first generates a prompt to be entered in the LLM from the analysis target data. In this case, the analytic query generation unit 52 makes an outline of the contents of the analysis target data and generates a prompt indicative of a sentence instructing the generation of queries suitable for the outline of the analysis target data. In the example shown in FIG. 6, the analytic query generation unit 52 generates a prompt that includes a first sentence indicating the outline of the analysis target data and the following second sentence “How the above data should be analyzed to get interesting results? Please output {n} queries in natural language”. Here, “outline of analysis target data” is, for example, text data obtained by summarizing the table, which is the analysis target data, with respect to each column or row of the table. The above-described prompt is an example of “text data including an outline of data and requesting the generation of a predetermined number of queries in accordance with the outline”.

Next, the analytic query generation unit 52 inputs the prompt to the LLM and thereby acquires one or more queries as analytic queries from the LLM. For example, if the learned configuration information (model information) of the LLM is stored in the storage device 4, the analytic query generation unit 52 inputs the prompt to the LLM configured by referring to learned parameters or the like indicated by the configuration information, and acquires the text data output by the LLM in response to the input. This text data indicates a text indicating one or more queries in accordance with the prompt. In FIG. 6, the LLM outputs text data indicating n queries (“1st query”, “2nd query”, “3rd query”, . . . , “n-th query”) according to the instructions in the prompt that n queries (n is an integer greater than or equal to 1) should be output. Here, the number n of the analysis queries may be any number. Use of multiple analysis queries improves the completeness of subsequent analyses. The number “n” is an example of a predetermined number.

The device which executes the LLM may be an external device capable of performing data communication with the data analysis device 1. In this instance, the analytic query generation unit 52 transmits the execution instruction signal of the LLM including the prompt to the external device through the interface 13, and receives the reply signal including the text data output by the LLM from the external device through the interface 13. Upon receiving the execution instruction signal, the external device transmits to the data analysis device 1 the reply signal including text data output by the LLM by inputting the prompt included in the execution instruction signal to the LLM. If any other process blocks other than the analytic query generation unit 52 uses the LLM or another model, the data analysis device 1 may also acquire the execution result of the model from the external device instead of executing the model by itself.

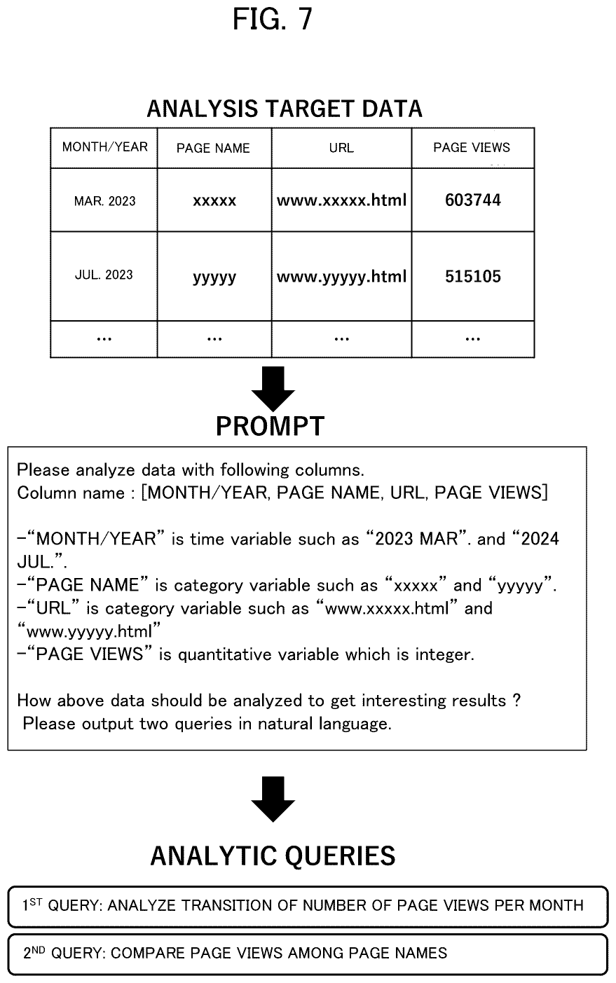

FIG. 7 illustrates a specific example of the generation of analytic queries using an LLM. The analysis target data shown in FIG. 7 is a table with column names of “month/year”, “page name”, “URL”, and “page view number”.

In this case, the analytic query generation unit 52 provides, in the prompt, an opening template sentence “Please analyze data with following columns” and an ending template sentence “How above data should be analyzed to get interesting results? Please output two queries in natural language”. Here, the number of queries “n” in FIG. 6 is set to “2”.

Further, the analytic query generation unit 52 provides series data “column name: [month/year, page name, URL, page views]” concatenated with commas and explanation of each column name between the starting template sentence and the ending template sentence. The explanation of each column name is, for example, a sentence including: a category (type of variable) of each column name; and examples of fields (which may be all fields) belonging to each column. In FIG. 7, the following explanations corresponding to the column names “month/year”, “page name”, “URL”, and “page views” are provided.
“MONTH/YEAR” is time variable such as “2023 March” and “2024 July”.
“PAGE NAME” is category variable such as “xxxxx” and “yyyyy”.
“URL” is category variable such as “www.xxxxx.html” and “www.yyyyy.html”.
“NUMBER OF PAGE VIEWS” is quantitative variable which is integer.

The analytic query generation unit 52 may determine the type of the above-described variable by any method. For example, the analytic query generation unit 52 may determine the above-described category by referring to a look-up or the like that indicates the combination of each possible column name and its type of the variable.

Next, the analytic query generation unit 52 acquires two queries (first query and second query) output by the LLM as analytic queries by inputting the above-described prompt to the LLM. Here, the analytic query generation unit 52 acquires the first query “analyze transition of page views per month” and the second query “compare page views among page names” as analytic queries.

As described above, the analytic query generation unit 52 acquires analytic queries suitable for analysis of the analysis target data based on the execution result of the LLM from a prompt in which the column names of the analysis target data are specified. Thus, the analytic query generation unit 52 can automatically generate the recommended analytic queries while having the LLM understand the outline of the data. In addition, the analysis based on various viewpoints becomes possible by combination with the generation of the insights in the subsequent stage.

### (5) Generation of Insights

Next, the generation process of the insights executed by the insight generation unit 53 will be described. The insight generation unit 53 generates the insight using the analysis target data and the analytic queries. Insights are generated for respective analytic queries. In this case, the insight generation unit 53 may generate the insight by any method. For example, the insight generation unit 53 may generate the insight using at least one of a chart recommendation model configured to recommend a chart that seems beneficial to humans and/or a question answering model configured to output an answer to an input query. Hereafter, an approach for generating an insight using either a chart recommendation model or a question answering model will be described as a representative example.

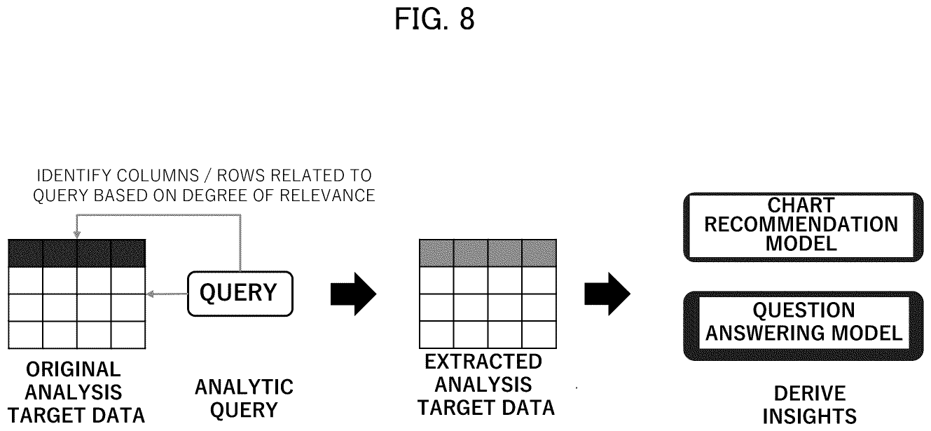

FIG. 8 illustrates an overview of the insight generation process. The process shown in FIG. 8 is performed for each analytic query.

First, the insight generation unit 53 extracts a part of columns or rows of the analysis target data related to the analytic query on the basis of the degree of relevance with the analytic query, and uses the extracted part of the columns or rows for subsequent analysis processing. In FIG. 8, “original analysis target data” refers to analysis target data before extraction based on the above-described degree of relevance, and “extracted analysis target data” refers to data consisting of columns or rows extracted from the analysis target data based on the above-described degree of relevance. For example, the insight generation unit 53 extracts columns (which may be rows instead of columns) of the analysis target data whose degree of relevance with the analytic query is equal to or larger than a predetermined threshold value. The above-described threshold value, for example, is stored in advance in the memory 12 or the like.

Here, the degree of relevance described above is an arbitrary index value representing the degree of relevance between each column or row of the analytic query and the analysis target data. Examples of the degree of relevance described above include the degree of similarity between the character string of the analytic query and the serial data of the each column or row, and the degree of similarity in the vector embeddings between the analytic query and the serial data described above. Here, the serial data is a character string in which elements of a column or a row are connected in series, and may conform to any format.

In some embodiments, only upon determining that a predetermined condition is satisfied, e.g., if the analysis target data is so enormous that it is not suitable for an input (prompt) to the chart recommendation model or the question answering model, the insight generation unit 53 may perform extraction processing based on the above-described degree of relevance. For example, if the number of characters of the analysis target data is equal to or more than a predetermined threshold value, the insight generation unit 53 determines that the present analysis target data is not suitable for the input to the chart recommendation model or the question answering model and performs extraction processing based on the above-described degree of the relevance.

Next, the insight generation unit 53 inputs data based on the analysis target data and the analytic query after extraction into the chart recommendation model or the question answering model. Then, the insight generation unit 53 acquires an insight based on the data output by the chart recommendation model or the question answering model.

Here, the chart recommendation model is a model configured to take as input a query and a table and output aggregated data (chart) obtained by aggregating the table related to the query. Examples of the chart recommendation model include a learning model based on deep learning such as QuickInsights. The parameters and the like for configuring the chart recommendation model are previously stored in the memory 12 or the like, and the insight generation unit 53 configures the chart recommendation model by referring to the parameters, and inputs the extracted analysis target data and the analytic query into the chart recommendation model. Then, the insight generation unit 53 acquires as an insight a chart output by the chart recommendation model in response to the above-described input.

In some embodiments, the insight generation unit 53 generates a summary of the analysis target data by verbalizing a chart output by the chart recommendation model, and may adopt the summary as an insight.

In this instance, in the first example, the insight generation unit 53 inputs, to a LLM such as a ChatGPT, a prompt instructing to verbalize the chart output by the chart recommendation model (i.e., convert the chart into a text). Then, the insight generation unit 53 acquires, as the summary of the analysis target data, the answer output by the LLM in response to the above-described input.

In the second example, the insight generation unit 53 uses a data-to-text generation model (text transformation model) based on a chart (which is assumed hereinafter to be a table) output by the chart recommendation model and the analytic query to generate text data, which describes the chart according to the analytic query, as a summary of the analysis target data. In this case, the insight generation unit 53 converts the chart into series data and combines the series data with the analytic query as context information, and inputs the combined data to the data-to-text model. The insight generation unit 53 acquires, as a summary of the analysis target data, the text output by the data-to-text model which takes the input described above. Here, the data-to-text model is a model trained to learn the relation between series data to which context information is attached and text data representing the explanatory sentence of the series data. The data-to-text model is, for example, a learning model based on deep learning, and examples of the data-to-text model include T5 (Text-to-Text Transfer Transformer). The parameters and the like for configuring the data-to-text model are previously stored in the memory 12 and the like, and the insight generation unit 53 configures the data-to-text model by referring to the parameters and the like.

The question answering model is a model configured to take as input a query and then output the answer to the query. For example, the question answering model is a learning model based on deep learning, and examples of the question answering model include ChatGPT and Unified SKG. The parameters and the like for configuring the question answering model are previously stored in the memory 12 or the like, and the insight generation unit 53 configures the question answering model by referring to the parameters and the like, and inputs a prompt based on the extracted analysis target data and the analytic query into the question answering model. Then, the insight generation unit 53 acquires, as an insight, an answer output by the question answering model in response to the above-described input. The acquired answer is equivalent to the summary of the analysis target data.

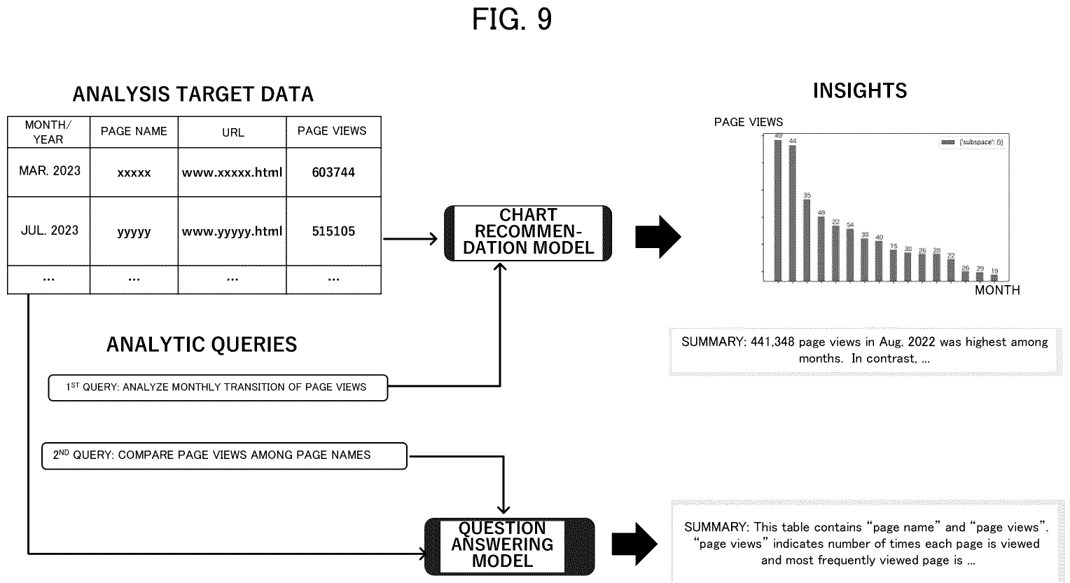

FIG. 9 shows a specific example of an insight generation process using a chart recommendation model and a question answering model. Here, an example using the analysis target data and the analytic queries (first query and second query) shown in FIG. 7 is shown.

The insight generation unit 53 inputs, into the chart recommendation model, the analysis target data regarding the number of page views for respective page names per month and the first query “Analyze transition of page views per month”. The chart recommendation model then outputs a graph of the number of page views per month. In addition, the insight generation unit 53 generates a text verbalized from the graph output by the chart recommendation model using ChatGPT or the like. This text is used as a summary of the analysis target data. Then, the insight generation unit 53 acquires, as the insights, a graph output by the chart recommendation model and a summary of the analysis target data which is verbalized graph. In some embodiments, the insight generation unit 53 extracts columns or rows of the analysis target data based on the degree of relevance with the first query, and uses extracted columns or rows in the above-described process.

The insight generation unit 53 inputs the data including the above-described analysis target data and the second query “compare page views among page names” into the question answering model. The data input to the question answering model is a query that requests a comparison of the numbers of page views among page names of the analysis target data described above. Thus, the question answering model outputs an answer representing a summary of the analysis target data. Then, the insight generation unit 53 acquires the answer output by the question answering model as the insight. In some embodiments, the insight generation unit 53 extracts the columns or rows of the analysis target data based on the degree of relevance with the second query to use only the extracted columns or rows in the above-described process.

Thus, the insight generation unit 53 can suitably generate the insights based on the analysis target data and analytic queries.

Here, a supplementary description will be given of the selection of the model used by the insight generation unit 53.

In the first example, the insight generation unit 53 may select whether to use the chart recommendation model or the query response model for each analytic query. In this case, the insight generation unit 53 inputs a prompt to the LLM such as ChatGPT asking whether to use the chart recommendation model or the question answer model when using the each analytic query. Then, the insight generation unit 53 selects whether to use the chart recommendation model or the question answer model based on the answer output by the LLM in response to the input.

In the second example, the insight generation unit 53 may use both the chart recommendation model and the question answering model to integrate the execution results. In this case, for example, the insight generation unit 53 acquires a text that integrates the summary generated through the chart recommendation model and the summary generated through the question answering model as an insight of the analysis target data. In the integration of the above-described summaries, for example, the insight generation unit 53 generates a prompt instructing to integrate the summary generated through the chart recommendation model and the summary generated through the question answer model, and inputs the prompt to the LLM. Then, the insight generation unit 53 acquires the answer output by the LLM in response to the above-described input as the insight representing the final summary of the analysis target data.

### (5) Generation of Metadata

Next, a process of generating metadata executed by the metadata generation unit 54 will be described. The metadata generation unit 54 generates metadata based on the insights generated by the insight generation unit 53. In this case, for example, the metadata generation unit 54 may use the summary and/or the chart that are insights as the metadata as they are. In another example, the metadata generation unit 54 may generate a tag to be attached to the analysis target data, an analysis type effective for analysis of the analysis target data, a highlight of the analysis target data, or the like from the summary generated as insights.

For example, the metadata generation unit 54 inputs to the LLM a prompt which instructs to generate a tag and an analytic type from the summary which is the insights. The metadata generation unit 54 determines the tag and the analysis type as the metadata of the analysis target data based on the answer output by the LLM in response to the above-described input.

In the past, the generation of tags and analysis types had to be performed manually, and workers had to visually check the contents of the analysis target data and manually perform tagging and generation of analysis types. On the other hand, in the present example embodiment, the data analysis device 1 automatically applies a tag or an analysis type using the generated insights without manually analyzing the contents of the data. Such tags and analysis types are suitably used as metadata to facilitate the retrieval of data desired by the user.

In another example, the metadata generation unit 54 inputs into the LLM a prompt which instructs to generate a highlight from the summary, which is the insights. The metadata generation unit 54 determines the highlight of the metadata of the analysis target data based on the text data output by the LLM in response to the above-described input. In general, it may be difficult for the user to analyze the summary of the individual analysis target data. In such a case, the user can easily grasp the analysis results by viewing the highlight, which enables to the user to determine whether or not to look through more detailed information. In this manner, the data analysis device 1 can support user's understanding by generating the highlight from the summary of the insights, smoothing the leads to analysis of interest, and improving user experience.

### (6) Display Example

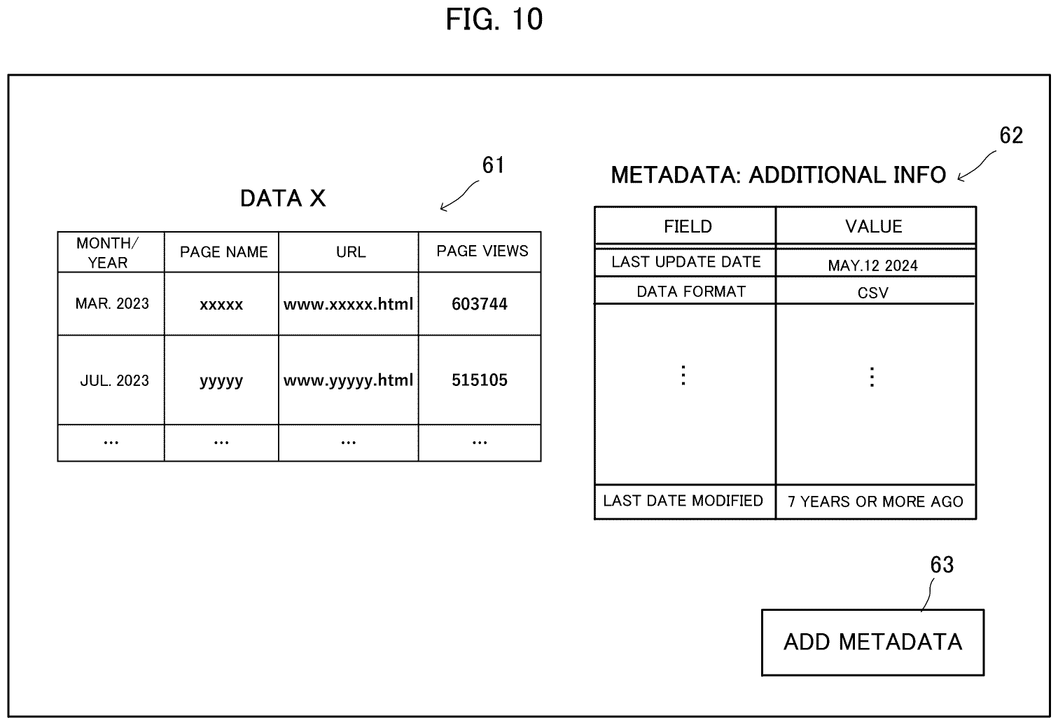

FIG. 10 is an example of a display of a data display screen image for the user to confirm the data and the metadata of the data. The UI controller 16 generates display information for displaying the data display screen image based on the processing result generated by the data analyzer 15, and transmits the generated display information to the display device 3 through the interface 13, thereby causing the display device 3 to display the data display screen image. Here, the UI controller 16 mainly provides a data display area 61, a metadata display area 62, and a metadata addition button 63.

The UI controller 16 displays the details of the user-specified data 6 (in this case, the data X) in the data display area 61 while displaying the metadata, which is associated with the data X in the data catalog 5, in the metadata display area 62. Here, for the data X, no metadata generation processing has not been performed by the data analysis device 1 yet, and only the default metadata of the data X is recorded in the data catalog 5.

Upon detecting that the metadata addition button 63 is selected, the UI controller 16 supplies an execution instruction of the metadata generation process with designation of the data X displayed in the data display area 61 as the analysis target data to the data analyzer 15. The data analyzer 15 receives the execution instruction and performs metadata generation process using the data X as the analysis target data. The UI controller 16 is an example of the “display control unit”.

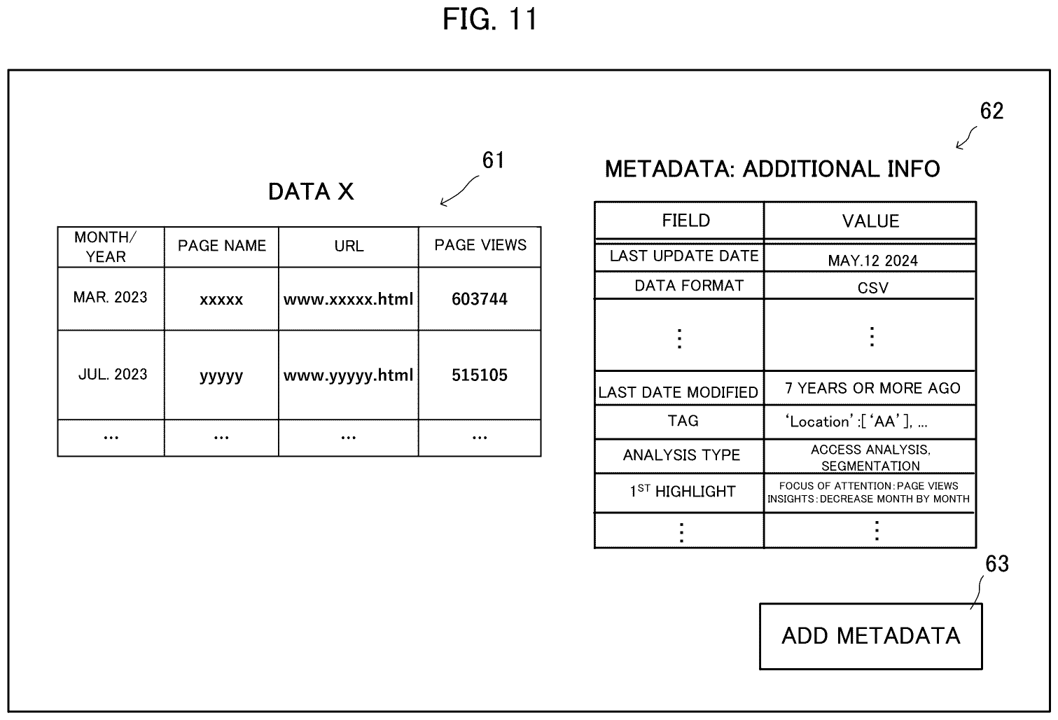

FIG. 11 is a display example of the data display screen image after the metadata addition button 63 has been selected. The data analyzer 15 performs the metadata generation process of the data X as the analysis target data, and the UI controller 16 additionally displays the metadata of the data X generated by the data analyzer 15 in the metadata display area 62.

In the example shown in FIG. 11, the data analyzer 15 generates a tag, an analysis type, and a highlight related to the data X as metadata of the data X. Here, the data analyzer 15 generates a value “AA” of the location “Location” related to the data X. The data analyzer 15 generates “access analysis” and “segmentation” as the values of the analysis type of the data X. Further, the data analyzer 15 generates at least “first Highlight” indicating that “focus of interest” is “page views” and “insights” is “decrease month by month” as one of the highlights of the data X. Here, in the column of the value of the first highlight is a hyperlink for displaying the insights used to generate the first highlight.

According to the display example shown in FIG. 11, the user can suitably confirm the generated metadata.

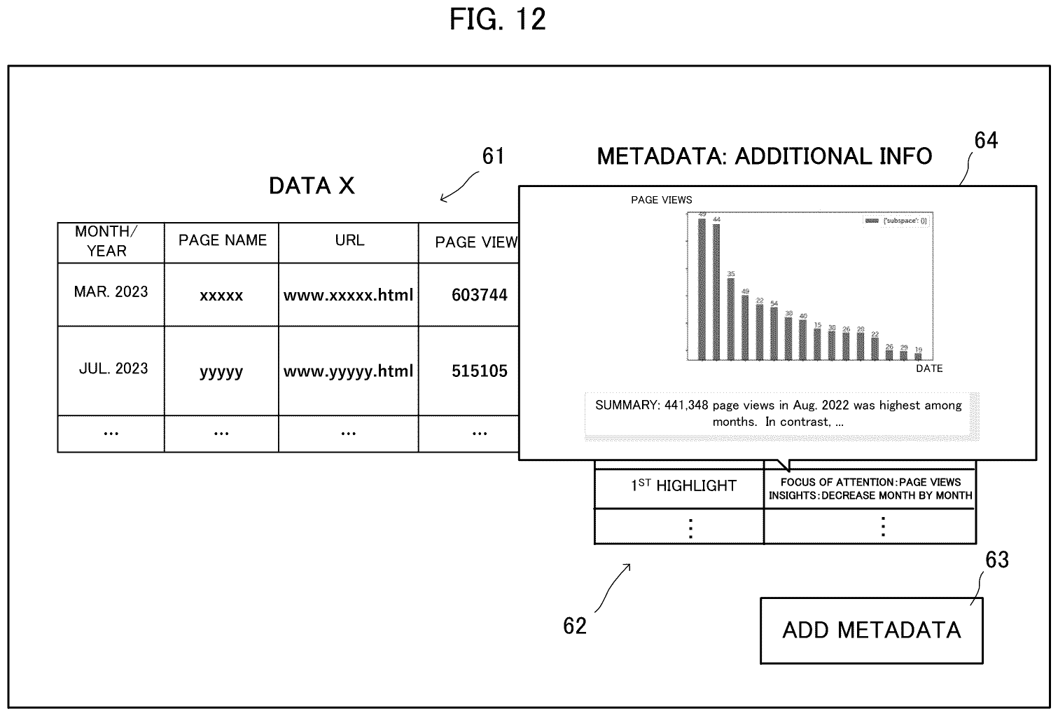

FIG. 12 is a display example of a data display screen image after a hyperlink in the field “fist highlight” is selected. In this case, the UI controller 16 displays an insight display window 64 for displaying insights used in generating the first highlight, and pops up the window in association with the field “first highlight” on the data display screen image.

In this instance, the UI controller 16 detects that the hyperlink in the field “first highlight” has been selected and receives from the data analyzer 15 the insights of the first highlight generated by the data analyzer 15. Here, the data analyzer 15 generates a chart and a summary based on the first query and the analysis target data, as shown in FIG. 9, and generates the first highlight from the generated summary. Accordingly, the UI controller 16 displays the insight display window 64 indicative of the chart and summary shown in FIG. 9.

Thus, according to the display example shown in FIG. 12, once the user shows an interest in the generated highlight, the UI controller 16 can display insights related to the highlight for the user to confirm the details of the analysis results as necessary.

In the above-described display example, the data analysis device 1 generates metadata of the data 6 based on manual designation by the user, but the approach for generating the metadata is not limited thereto. For example, the data analysis device 1 may perform a metadata generation process upon detecting any piece of data 6 is updated or a preset of a tag is changed. In this way, in some embodiments, upon determining that a predetermined condition for metadata generation or update is satisfied, the data analysis device 1 automatically generates the metadata and updates the data catalog 5, so that the data catalog 5 is kept in a state in accordance with the latest data 6.

### (7) Process Flow

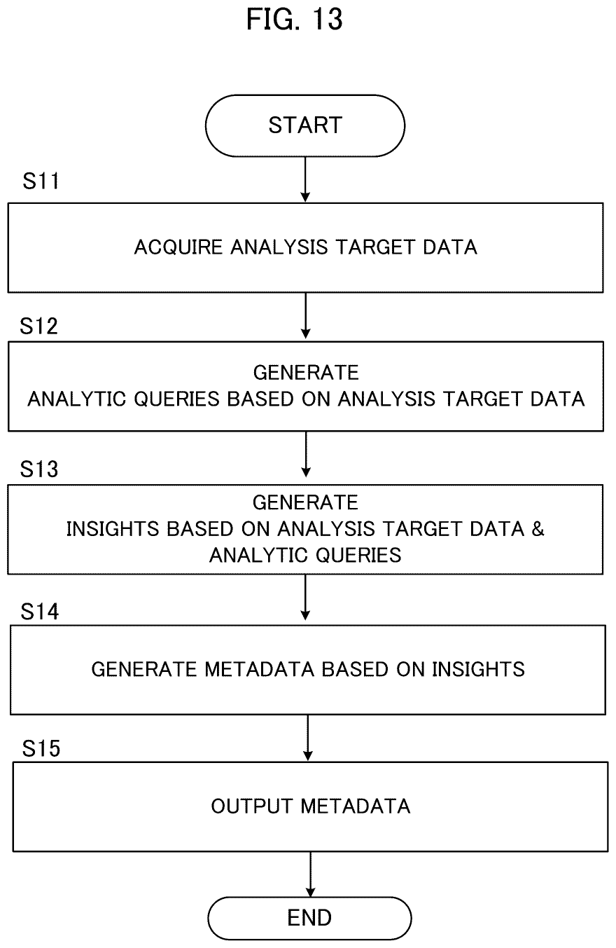

FIG. 13 is an example of a flowchart showing an outline of the processing performed by the data analysis device 1.

First, the data analysis device 1 acquires the analysis target data (step S11). In this case, the data analysis device 1 selects analysis target data from the data 6 stored in the storage device 4.

Then, the data analysis device 1 generates analytic queries based on the analysis target data acquired at step S11 (step S12). Then, the data analysis device 1 generates insights of the analysis target data on the basis of the analysis target data acquired at step S11 and the analytic queries generated at step S12 (step S13). Then, the data analysis device 1 generates the metadata of the analysis target data based on the insights generated at step S13 (step S14). Then, the data analysis device 1 outputs the metadata generated at step S14 (step S15). In this case, the data analysis device 1 associates the metadata with the analysis target data and registers the data in the data catalog 5, or displays information on the generated metadata on the display device 3.

### Second Example Embodiment

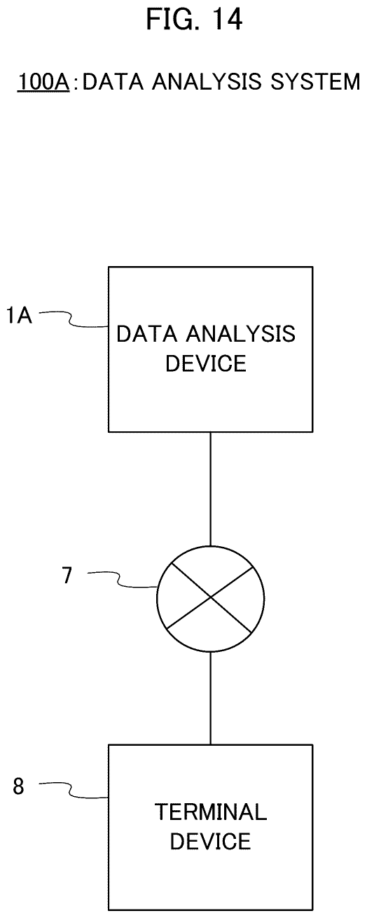

FIG. 14 shows the configuration of the data analysis system 100A. The data analysis system 100A mainly includes a data analysis device 1A and a terminal device 8. The data analysis device 1A and the terminal device 8 performs data communication with each other via the network 7.

The data analysis device 1A is one or more devices that function as a server (including cloud server) and performs processes related to data analysis executed by the data analysis device 1 in the first example embodiment. In this instance, the data analysis device 1A receives the input information, which the data analysis device 1 received from the input device 2 in the first example embodiment, from the terminal device 8 via the network 7. The data analysis device 1A transmits the display information, which was transmitted to the display device 3 by the data analysis device 1 in the first example embodiment, via the network 7 to the terminal device 8. The data analysis device 1A also stores the data catalog 5 and the data 6 or refers to the data catalog 5 and the data 6 via the network 7.

The terminal device 8 is a terminal equipped with an input function, a display function, and a communication function, and functions as the input device 2 and the display device 3 in the first example embodiment. The terminal device 8 may be, for example, a personal computer, a tablet-type terminal, a PDA (Personal Digital Assistant), or the like. The terminal device 8 transmits input information generated based on the received user input to the data analysis device 1A through the network 7. Further, upon receiving the display information from the data analysis device 1A, the terminal device 8 displays information based on the display information.

The data analysis device 1A according to the second example embodiment can execute the input process and output process for the user of the terminal device 8 in the same way as the data analysis device 1 in the first example embodiment.

### Third Example Embodiment

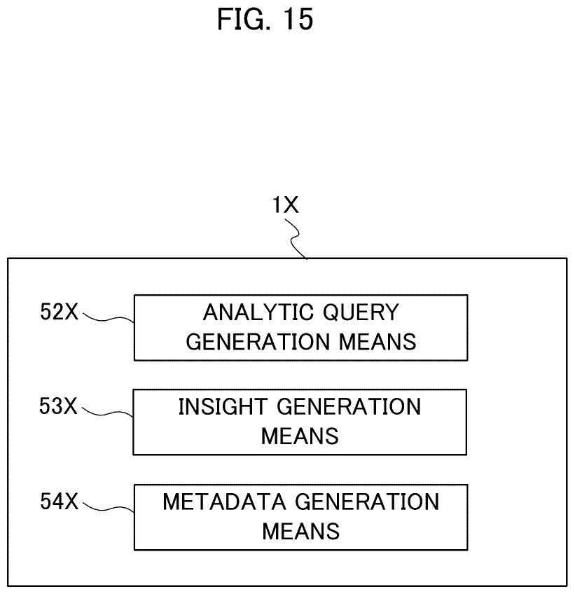

FIG. 15 is a functional block diagram of the data analysis device 1X. The data analysis device 1X mainly includes an analytic query generation means 52X, an insight generation means 53X, and a metadata generation means 54X. The data analysis device 1X may be configured by a plurality of devices.

The analytic query generation means 52X is configured to generate, from data, an analytic query for analyzing the data. Examples of the analytic query generation means 52X include an analytic query generation unit 52 according to the first example embodiment or the second example embodiment.

The insight generation means 53X is configured to generate an insight of the data based on the data and the analytic query. Examples of the insight generation means 53X include the insight generation unit 53 in the first example embodiment or the second example embodiment.

The metadata generation means 54X is configured to generate metadata of the data based on the insight. Examples of the metadata generation means 54X include the metadata generation unit 54 according to the first example embodiment or the second example embodiment.

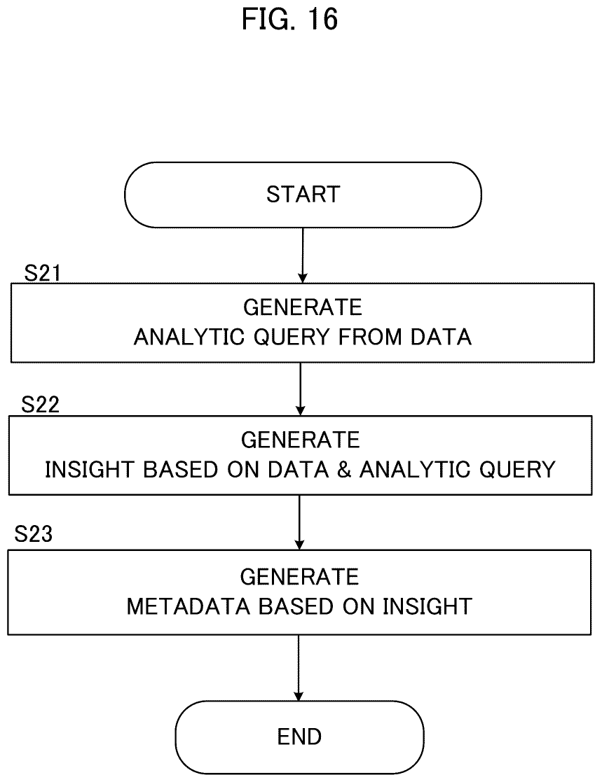

FIG. 16 is an exemplary flowchart that is performed by the data analysis device 1X. The analytic query generation means 52X generates, from data, an analytic query for analyzing the data (step S21). The insight generation means 53X generates an insight of the data based on the data and the analytic query (step S22). The metadata generation means 54X generates metadata of the data based on the insight (step S23).

The data analysis device 1X according to the third example embodiment can automatically generate metadata suitable for invoking, retrieval, and understanding based on the insight of the data.

In addition, some or all of the above-described example embodiments (including modifications, the same shall apply hereinafter) may also be described as follows, but are not limited to the following. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### Supplementary Note 1

A data analysis device comprising:
an analysis query generation means configured to generate, from data, an analytic query for analyzing the data;
an insight generation means configured to generate an insight of the data based on the data and the analytic query; and
a metadata generation means configured to generate metadata of the data based on the insight.

### Supplementary Note 2

The data analysis device according to Supplementary Note 1,
wherein the insight generation means is configured to generate, as the insight, text data obtained by summarizing the data, and
wherein the metadata generation means is configured to generate, based on the text data, the metadata which includes at least one of
   a tag regarding the data,
   an analysis type regarding the data, and/or
   a highlight regarding the data.

### Supplementary Note 3

The data analysis device according to Supplementary Note 1,
wherein the analytic query generation means is configured to
   input, into a language model, as a prompt, text data which includes an outline of the data and which instructs to generate a predetermined number of queries in accordance with the outline, and
   acquire, as the analytic queries, the predetermined number of queries output by the language model,
wherein the language model is trained through machine learning to take, as input, the prompt and output an answer to the prompt.

### Supplementary Note 4

The data analysis device according to Supplementary Note 1,
wherein the data is a table, and
wherein the insight generation means is configured to
   extract some columns or rows of the table based on a degree of relevance between the analytic query and each column or row of the table and
   generate the insight based on the extracted columns or rows.

### Supplementary Note 5

The data analysis device according to Supplementary Note 1,
wherein the insight generation means is configured to execute the instructions to acquire, as the insight, at least one of
   a chart output by a chart recommendation model based on the data and the analytic query and/or
   text data obtained by verbalizing the chart.

### Supplementary Note 6

The data analysis device according to Supplementary Note 1,
wherein the insight generation means is configured to execute the instructions to acquire, as the insight, text data output by a question answering model based on data and the analytic query.

### Supplementary Note 7

The data analysis device according to Supplementary Note 1,
wherein the data is target data of search registered in a data catalog, further comprising an output means configured to update the data catalog based on the metadata.

### Supplementary Note 8

The data analysis device according to Supplementary Note 1, further comprising
a display control means configured to cause a display device to display the metadata together with the data.

### Supplementary Note 9

A data analysis method executed by a computer, comprising:
generating, from data, an analytic query for analyzing the data;
generating an insight of the data based on the data and the analytic query; and generating metadata of the data based on the insight.

### Supplementary Note 10

A program executed by a computer, the program causing the computer to:
generate, from data, an analytic query for analyzing the data;
generate an insight of the data based on the data and the analytic query; and generate metadata of the data based on the insight.

### Supplementary Note 11

A storage medium storing a program according to Supplementary Note 10.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1, 1A, 1X Data analysis device
2 Input device
3 Display device
5 Data catalog
6 (6A,6B, . . . ) Data
7 Network
8 Terminal device
100, 100A Data analysis system

What is claimed is:

1. A data analysis device comprising:
at least one memory configured to store instructions, and
at least one processor configured to execute the instructions to:
generate, from data, an analytic query for analyzing the data;
generate an insight of the data based on the data and the analytic query; and
generate metadata of the data based on the insight.

2. The data analysis device according to claim 1,
wherein the at least one processor is configured to execute the instructions to
generate, as the insight, text data obtained by summarizing the data,
generate, based on the text data, the metadata which includes at least one of
a tag regarding the data,
is an analysis type regarding the data, and/or
a highlight regarding the data.

3. The data analysis device according to claim 1,
wherein the at least one processor is configured to execute the instructions to
input, into a language model, as a prompt, text data which includes an outline of the data and instructions to generate a predetermined number of queries in accordance with the outline, and
acquire, as the analytic queries, the predetermined number of queries output by the language model,
wherein the language model is trained through machine learning to take, as input, the prompt and output an answer to the prompt.

4. The data analysis device according to claim 1,
wherein the data is a table, and
wherein the at least one processor is configured to execute the instructions to
extract some columns or rows of the table based on a degree of relevance between the analytic query and each column or row of the table and
generate the insight based on the extracted columns or rows.

5. The data analysis device according to claim 1,
wherein the at least one processor is configured to execute the instructions to acquire, as the insight, at least one of
a chart output by a chart recommendation model based on the data and the analytic query and/or
text data obtained by verbalizing the chart.

6. The data analysis device according to claim 1,
wherein the at least one processor is configured to execute the instructions to acquire, as the insight, text data output by a question answering model based on data and the analytic query.

7. The data analysis device according to claim 1,
wherein the data is target data of search registered in a data catalog, and
wherein the at least one processor is configured to execute the instructions to update the data catalog based on the metadata.

8. The data analysis device according to claim 1,
wherein the at least one processor is configured to execute the instructions to cause a display device to display the metadata together with the data.

9. A data analysis method executed by a computer, comprising:
generating, from data, an analytic query for analyzing the data;
generating an insight of the data based on the data and the analytic query; and
generating metadata of the data based on the insight.

10. A non-transitory computer readable storage medium storing a program executed by a computer, the program causing the computer to:
generate, from data, an analytic query for analyzing the data;
generate an insight of the data based on the data and the analytic query; and
generate metadata of the data based on the insight.
